(19) United States
(12) Patent Application Publication
(10) Pub. No.: US 2022/0241815 A1
(43) Pub. Date: Aug. 4, 2022

(54) DEVICE AND METHOD FOR COATING WORKPIECES

(71) Applicant: HOMAG GmbH, Schopfloch (DE)

(72) Inventors: Reiner GÖTZ, Horb-Diessen (DE); Jonathan WÜRZ, Dornhan (DE); Markus BLATTNER, Waldachtal (DE); Yimin GAN, Rottenburg am Neckar (DE); Martin CALMBACH, Schopfloch (DE)

(73) Assignee: HOMAG GmbH, Schopfloch (DE)

(21) Appl. No.: 17/612,748

(22) PCT Filed: May 20, 2020
(86) PCT No.: PCT/EP2020/064095

§ 371 Date: Nov. 19, 2021

(30) Foreign Application Priority Data
May 23, 2019 (DE) 10 2019 113 794.2

(51) Int. Cl. B05D 1/26; B27D 5/00; B05C 5/02

(52) U.S. Cl. CPC B05D 1/26; B05C 5/0225; B05C 5/0204; B27D 5/003

(57) ABSTRACT

A device according for coating workpieces of wood, wood materials, plastic, aluminium or the like, includes: a feed device for feeding a coating material; a pressing device for pressing the coating material onto a surface of a workpiece; a conveying device for inducing a relative movement between the pressing device and the respective workpiece; and an activation device for activating an adhesive on a coating material fed by the feed device and/or for activating an adhesive on a surface of a workpiece to be coated. The activation device includes at least one supply line for supplying an activation medium as well as a nozzle body having an activation medium inlet duct and an activation medium outlet region. The activation medium outlet region includes at least one outlet opening. The activation device also includes precisely one closure to close the outlet opening of the activation medium outlet region.

### TECHNICAL FIELD

The invention relates to a device and a method for coating workpieces preferably consisting at least in parts of wood, wood materials, plastic, aluminium or the like. The invention furthermore relates to the use of a device according to the invention.

### PRIOR ART

In the furniture and components industry, for example, workpieces are often provided with a coating material on one their surfaces, for instance an edge. The coating material is usually attached by means of a suitable adhesive applied to the workpiece or coating material in the form of a hot-melt adhesive, for example. However, an adhesive can also be used that is applied to the workpiece or coating material and is activated during the coating process by means of hot air.

Disclosed in DE 202012013116 U1 is a nozzle arrangement for an edge-strip application device that is suitable for applying hot air to an edge strip or workpiece. This nozzle arrangement comprises at least two groups of air outlet openings and a number of cylindrical closure members corresponding to the number of groups of air outlet openings.

However, it has been shown that the sealing of closure members and in particular the sealing of closure members to which hot air is applied is complex and expensive.

Furthermore, closure members tend to get stuck or jam during traversing or displacement movements. In addition, the closure members disclosed in DE 202012013116 U1 are associated with increased manufacturing costs owing to their geometry and interaction. The comparatively large contact areas between the closure members and other components of the nozzle arrangement also promote wear of the device.

### DESCRIPTION OF THE INVENTION

An object of the invention is to provide a simple and efficient way of activating an adhesive on a coating material and/or on a workpiece.

According to the invention, this object is solved by a device according to claim 1. Preferred embodiments are specified in the sub-claims.

A device according to the invention for coating workpieces preferably consisting at least in parts of wood, wood materials, plastic, aluminium or the like, comprises: a feed device for feeding a coating material; a pressing device for pressing the coating material onto a surface of a workpiece; a conveying device for inducing a relative movement between the pressing device and the respective workpiece; and an activation device for activating an adhesive on a coating material fed by the feed device and/or for activating an adhesive on a surface of a workpiece to be coated. The activation device comprises at least one supply line for supplying an activation medium as well as a nozzle body having an activation medium inlet duct and an activation medium outlet region. The activation medium outlet region comprises at least one outlet opening, preferably at least two groups of outlet openings. The activation device further comprises precisely one closure means that is configured to close the outlet opening and/or individual outlet openings of the activation medium outlet region at least in parts.

The activation medium may be, for example, heated air or another gas.

In the present context, a group of outlet openings may comprise 2, 10 or 100 outlet openings, for example. A group of outlet openings may be formed, for instance, by outlet openings arranged next to each other or one below the other. However, a group of outlet openings may also be formed in such a manner that individual outlet openings of a substantially uniform grid of outlet openings are assigned to one group. An activation medium outlet region may comprise a grid of outlet openings, for example, a grid in which outlet openings are arranged in a horizontal direction and a vertical direction. The closure means may be configured to simultaneously close outlet openings of different groups of outlet openings.

In the present case, an outlet opening is deemed to be closed when an activation medium introduced into the nozzle body through the activation medium inlet duct is substantially prevented from exiting the outlet opening.

The closure means is preferably configured in such a manner that optionally all outlet openings, no outlet openings or a selection of outlet openings can be closed.

One advantage of the device according to the invention is that a single closure means can be used to close a plurality of or all outlet openings. In this manner, the complexity of the device and thus also its susceptibility to errors is reduced as compared to the prior art. Owing to the low complexity of the device, the manufacturing costs for the device can, in turn, be reduced. Furthermore, a lower susceptibility to errors can be achieved, which is accompanied by an increased service life. A cost-effective use of the device can therefore be made possible.

In a device according to the invention, the closure means may be a slider that is preferably substantially plate shaped and has a thickness of between 0.1 mm and 200 mm inclusive, preferably between 0.1 mm and 1 mm inclusive, and particularly preferred between 0.2 mm and 0.5 mm inclusive. The slider may be configured to assume different positions relative to the nozzle body by means of translational movement parallel to a first direction and/or by means of rotational movement about an axis of rotation, with different numbers of outlet openings being fluidically connected to the activation medium inlet duct in different positions of the slider.

One advantage of a plate-shaped slider, in particular a plate-shaped slider having the thickness described above, is its flexibility. Such a slider allows, for example, an inclination of the nozzle body to be adjusted without having to change the inclination of the closure means and/or the inclination of a kinematics to shift/rotate the closure means. Similarly, the lower limit of the thickness of the slider is selected such that, despite its high flexibility, the slider is substantially rigid, i.e. is not damaged during closure.

In a device according to the invention, the slider may be configured to descend into a first end portion of the nozzle body. In the region of the first end portion, the nozzle body may comprise at least one guide member for guiding the slider, which, with respect to the first direction, takes up, for example, at least 10%, preferably at least 30% and particularly preferred at least 50% of the length of the slider, relative to the first direction. Such a guide member can prevent the slider from becoming stuck, in particular in the case of sliders with a high length-to-width ratio. The nozzle body and the closure means are preferably formed from the same or similar materials, for example steel. In this manner, jamming of the closure means, for example due to thermally induced expansion effects, can be prevented.

In a device according to the invention, the closure means may be arranged upstream of the outlet openings relative to the intended flow direction of the activation medium. In this arrangement, the flow of the activation medium can advantageously press the closure means against the outlet openings from the inside of the nozzle body, which can improve a sealing effect of the closure means. A smaller amount of the activation medium can thus escape due to leakage flows, which further improves the efficiency of the device. The advantages described above are enhanced if the closure means is a thin plate having, for example, the thickness described above.

If the closure means is arranged upstream of the outlet openings relative to the intended flow direction of the activation medium, the nozzle body may comprise an interior space, preferably precisely one interior space. This interior space may be fluidically connected to or brought into fluid connection with both the activation medium inlet duct and the outlet openings. A guide member for guiding the closure means may be formed in at least one section of the interior space. The guide member may be, for example, a groove or a rail. The guide member can make it possible to guide the closure means over a relatively long length. In this manner, the risk of the closure means becoming stuck can be reduced.

In a device according to the invention, the nozzle body may be formed of a plurality of interconnected components, the closure means being slidably arranged between at least two of the plurality of interconnected components. However, the nozzle body may also be configured as a one-part nozzle body. A one-part nozzle body may be produced, for example, by means of an additive manufacturing process. A multi-part nozzle body may have advantages in terms of manufacturing costs. The manufacturing of a one-part nozzle body by means of an additive manufacturing process may in particular be advantageous if the nozzle body has a complex geometry.

In a device according to the invention, the closure means may be arranged downstream of the outlet openings relative to the intended flow direction of the activation medium. In this manner, the accessibility of the closure means can be improved, for example. This can in particular facilitate service or replacement of the closure means.

The device described above may comprise a guide member for guiding the closure means on at least one side portion, preferably on two side portions of the activation medium outlet region. The guide member may be configured, for example, as a guide rail or guide groove. A guide member may be advantageous in the present context in that it can absorb the pressure applied to the closure means by the flow of the activation medium. This can counteract an undesirable elastic or plastic deformation of the closure means.

In a device according to the invention, the activation medium inlet duct may be formed in the first end portion. The first end portion is the portion of the nozzle body into which the slider descends. In one use of the device according to the invention, the first end portion is preferably located at an upper side of the device (relative to the direction of gravity). This arrangement advantageously makes it possible to prevent collisions in the installation space between workpiece-related and/or coating material-related contours and the activation medium inlet duct, the supply line as well as the closure means.

Alternatively or additionally, however, the activation medium inlet duct may also be formed in a second end portion that is different from the first end portion. The second end portion is preferably located opposite the first end portion or the activation medium outlet region. If the second end portion in which the activation medium inlet duct is formed is located opposite the activation medium outlet region, a uniform outflow of the activation medium from the outlet openings can be promoted.

In a device according to the invention, the first direction and a main axis of the activation medium inlet duct may form an angle of between 5° and 90° inclusive, preferably between 45° and 90° inclusive, and particularly preferred between 60° and 90° inclusive. Such an inclination of the activation medium inlet duct relative to the first direction, which is a displacement direction of the closure means, can be associated with advantages in terms of flow dynamics, for example.

In a device according to the invention, a first outlet opening may have a larger cross-section than a second outlet opening. The first outlet opening is preferably further away from the activation medium inlet duct than the second outlet opening. In this manner, it can be made possible to compensate for flow losses that can lead to a reduction in the corresponding outflow velocity, particularly in the case of large distances between the activation medium inlet duct and an outlet opening. The uniformity of the flow of the activation medium can therefore be promoted by different sized cross-sections of the outlet openings.

In a device according to the invention, the closure means may comprise closure means openings which are arranged in such a manner that at least one of the closure means openings can be brought into fluidic connection, at least in part, with at least one outlet opening by shifting the closure means. The closure means preferably comprises at least one closure means opening that has a larger opening cross-section than another closure means opening.

For example, a closure means described above may have elongated holes in a first portion and circular holes in a second portion. The width of the elongated holes may correspond to the diameter of the circular holes, and the length of the elongated holes may be greater than the diameter of the circular holes. In a first state, for example, a first group of outlet openings of the nozzle body may be fluidically connected to the elongated holes and a second group of outlet openings of the nozzle body may be fluidically connected to the circular holes of the closure means. In a second state, in which the closure means has been moved by displacement into a different position, the first group of outlet openings, for example, may still be fluidically connected to the elongated holes, but the second group of outlet openings may no longer be connected to the circular holes.

The device described above may have the advantage over other devices that the displacement path that must be travelled by the closure means in order to close or open a certain number of outlet openings can be reduced. Consequently, an actuator with a smaller size can be used to actuate the closure means, allowing a compact system layout to be achieved.

In a device according to the invention, the closure means may comprise at least one first portion in which a first number of closure means openings per area is provided. In addition, the closure means may comprise at least one second portion in which a second number of closure means openings per area are provided, the first number per area and the second number per area being different numbers per area.

Alternatively or additionally, in a device according to the invention, the nozzle body may comprise at least one first portion in which a first number of outlet openings per area is provided, and at least one second portion in which a second number of outlet openings per area is provided, the first number per area and the second number per area being different numbers per area. A number of openings per area is also referred to in the following as opening density.

A portion of the nozzle body and/or of the closure means that is located further away from the activation medium inlet duct preferably has a higher opening density (based on outlet openings and/or closure means openings) than a portion of the nozzle body and/or of the closure means that is located closer to the activation medium inlet duct. In this manner, it can be made possible, for example, to compensate for flow losses, and thus to achieve a substantially even volumetric flow of activation medium in different portions of the nozzle body (or the closure means). A nozzle body and/or a closure means preferably comprises a plurality of portions with a plurality of different opening densities (based on outlet openings and/or closure means openings). Particularly preferably, the opening density (based on outlet openings and/or closure means openings) increases gradually with the distance to the activation medium inlet duct.

In a device according to the invention, the nozzle body may comprise at least one interior space, preferably precisely one interior space, which is or can be brought into fluidic connection with the activation medium supply opening and with the outlet openings, said interior space preferably not being rotationally symmetrical. A rotationally symmetrical interior space may be a cylindrical bore, for example. A non-rotationally symmetrical interior space may have a cubic shape, for example. A non-rotationally symmetrical interior space may, for example, also have a substantially wedge-shaped or trapezoidal cross-section. By deviating from a rotationally symmetrical shape, it can be made possible to provide an interior space which is configured in a manner that is favourable in terms of flow and which can also be fluidically connected to and/or brought into fluid connection with a plurality of outlet openings.

If the nozzle body comprises an interior space, it may comprise at least one flow directing member configured to mix and/or direct the activation medium. The flow directing member is preferably configured to influence the flow of the activation medium in such a manner that the average outflow velocities of individual outlet openings fluidically connected to the activation medium inlet duct do not deviate from one another by more than 50%, preferably not more than 20% and particularly preferred not more than 5%. In this manner, it can be made possible to increase the uniformity of the flow and thus also the reproducibility of a method that can be carried out using the device.

A device according to the invention may comprise an adhesive application unit configured to apply adhesive to a coating material fed by the feed device and/or to a surface of a workpiece to be coated. An adhesive application unit may be a glue roller, for example. A device can therefore be provided that can be used for conventional edge coating by means of glue application and/or for edge coating with an activatable adhesive. The flexibility of the device can be increased in this manner.

A device according to the invention may be configured to rotate at least the activation device and/or the pressing device about at least one axis, preferably about a C axis. In the present case, a C axis is an axis perpendicular to a machining table, which the device according to the invention may further comprise. A device according to the invention may furthermore be configured to rotate at least the activation device and/or the pressing device about an F axis. In the present context, an F axis is an axis that is different to the C axis.

In a device according to the invention, the closure means may comprise a plurality of sectors that differ from one another. A first number of closure means openings may be formed in a first sector of the plurality of sectors and a second number of closure means openings may be formed in a second sector of the plurality of sectors. In such a device, closure means openings of the first sector or closure means openings of the second sector can be brought into fluidic connection, at least in parts, with the at least one outlet opening of the nozzle body by rotation and/or translation of the closure means. The first number and the second number are different numbers in this case. Alternatively or in addition to the different numbers of closure means openings in the different sectors, the first sector and the second sector may comprise closure means openings with different opening cross-sections.

The closure means described above is preferably configured to be substantially circular and comprises, for example, three, four, five or any other number of circular sectors, each having a different number of closure means openings to the other. For example, a first sector may have five closure means openings, a second sector may have ten closure means openings, a third sector may have 15 closure means openings, and so on. The closure means may furthermore comprise at least one sector in which no closure means openings are formed. The device may, for example, be configured in such a manner that, by rotating the circular closure means about a centre of a circle, closure means openings of the first sector, closure means openings of the second sector, or closure means openings of the third sector, etc., are selectively brought into fluidic connection with the at least one outlet opening of the nozzle body. The at least one outlet opening of the nozzle body may, for example, be precisely one outlet opening that is preferably configured to be substantially slit-shaped.

With the device described above, a simple and cost-effective arrangement can be provided that allows the outflow of the activation medium to be adapted to different coating materials and/or workpieces, even if installation space is limited.

In one use according to the invention of a device according to the invention, the nozzle body is moved relative to the closure means, the closure means being substantially stationary. The direction of movement of the nozzle body preferably has a component that is parallel to the direction of gravity. For example, the closure means may be a body that comprises a cavity. In this case, outlet openings of the nozzle body may be closed by a surface of the cavity when the nozzle body descends into the cavity. In such a use, the nozzle body may, for example, be guided through the cavity at its underside and thus have an increased degree of stability.

According to the invention, a method is provided for coating and/or activating workpieces preferably consisting at least in part of wood, wood materials, plastic, aluminium or the like. In a method according to the invention, a device for coating workpieces is used, preferably one of the devices described above. The device for coating workpieces comprises an activation device for activating an adhesive on a coating material fed by a feed device and/or for activating an adhesive on a surface of a workpiece to be coated. The activation device comprises at least one supply line for supplying an activation medium as well as a nozzle body having an activation medium inlet duct and an activation medium outlet region. The activation medium outlet region comprises at least one outlet opening, preferably at least two groups of outlet openings. The activation device further comprises precisely one closure means that is configured to close the outlet opening and/or individual outlet openings at least in parts. A method according to the invention comprises at least the following steps:
Actuating the precisely one closure means such that at least parts of the at least one outlet opening of the nozzle body which are not opposite a coating material and/or a surface of a workpiece to be coated are closed;
Inducing a relative movement between the pressing device and the respective workpiece by means of a conveying device;
Feeding the coating material by means of a feed device;
Applying and/or activating an adhesive on a coating material fed in the feed device and/or a surface of a workpiece to be coated by means of the device for coating workpieces;

The step of actuating the closure means is preferably carried out in such a manner that all outlet openings of the nozzle body that are not opposite a coating material and/or a surface of a workpiece to be coated are partially or completely closed.

The same or comparable advantages to the device according to the invention described above can also be assigned to a method according to the invention. Furthermore, both the device according to the invention and the method according to the invention can make it possible to apply the activation medium only to a surface to be activated of a coating material and/or a workpiece to be coated. Consequently, damage to other surfaces of the workpiece and/or the coating material by the activation medium can be prevented.

### BRIEF DESCRIPTION OF THE FIGURES

FIG. 1 shows a perspective view of a first embodiment of a device according to the invention;

FIG. 2a shows an exploded perspective view of the nozzle body of the first embodiment of a device according to the invention;

FIG. 2b shows an exploded perspective view of the nozzle body of a variant of the first embodiment of a device according to the invention;

FIG. 3a shows an exploded perspective view of the nozzle body and the closure means of the variant of the first embodiment of a device according to the invention in a first state;

FIG. 3b shows an exploded perspective view of the nozzle body and the closure means of the variant of the first embodiment of a device according to the invention in a second state;

FIG. 3c shows an exploded perspective view of the nozzle body and the closure means of the variant of the first embodiment of a device according to the invention in a third state;

FIG. 4a shows a perspective view of the nozzle body and the closure means of a second embodiment of a device according to the invention in a first state;

FIG. 4b shows a perspective view of the nozzle body and the closure means of the second embodiment of a device according to the invention in a second state;

FIG. 4c shows a perspective view of the nozzle body and the closure means of a variant of the second embodiment of a device according to the invention.

### Detailed Description of Preferred Embodiments

The preferred embodiments of the present invention described below are merely examples and should not be seen as limiting. Identical reference numbers specified in different figures designate identical, corresponding or functionally similar elements.

FIG. 1 shows a perspective view of a first embodiment of a device according to the invention. The device comprises a feed device for feeding a coating material 10, a pressing device 20 for pressing the coating material 10 onto a surface 31 of a workpiece 30, a conveying device for inducing a relative movement between the pressing device 20 and the respective workpiece 30, and an activation device 40 for activating an adhesive on a coating material 10 fed by the feed device. In the shown case, the pressing device 20 is configured as a pressure roller 20. The feed device and the conveying device are not shown in FIG. 1. The activation device 40 comprises at least one supply line for supplying an activation medium as well as a nozzle body 50 having an activation medium inlet duct 60 and an activation medium outlet region 80. The activation medium outlet region 80 comprises outlet openings 90. Depending on how it is viewed, it may be stated, for example, that the activation medium outlet region 80 shown in FIG. 1 has two groups of outlet openings or ten groups of outlet openings each lying vertically one underneath the other. The activation device 40 comprises precisely one closure means 110, which is configured to close individual outlet openings 90.

The closure means 110 of the first embodiment as shown in FIG. 1 is a slider 110 that is substantially plate shaped and has a thickness of between 0.1 mm and 200 mm inclusive, preferably between 0.1 mm and 1 mm inclusive, and particularly preferred between 0.2 mm and 0.5 mm inclusive. The slider 110 shown in FIG. 1 is configured to assume various positions relative to the nozzle body 50 by means of translational movement parallel to a first direction. The first direction may substantially correspond to the direction of gravity. The slider 110 of the first embodiment is configured to close different numbers of outlet openings 90 in different positions relative to the nozzle body 50. The slider 110 is furthermore configured to descend into a first end portion of the nozzle body 50. As shown in FIG. 1, the first end portion may be an upper end portion of the nozzle body 50. In the device of the first embodiment, the slider 110 is arranged upstream of the outlet openings 90 relative to the intended flow direction of the activation medium, i.e. inside the nozzle body 50. The nozzle body 50 of the first embodiment is furthermore formed from a plurality of interconnected components 50a, 50b. The nozzle body 50 shown in FIG. 1 comprises a nozzle block 50a and a perforated plate 50b which are connected to each other and between which the slider 110 is slidably arranged.

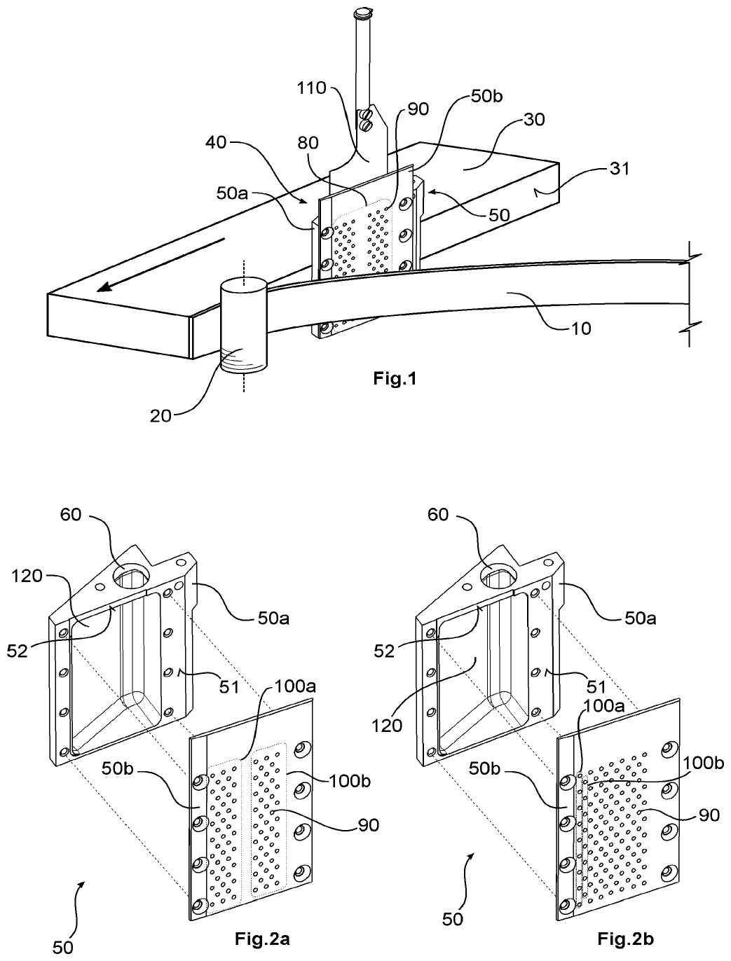

FIGS. 2a and 2b each show an exploded perspective view of the nozzle body of the first embodiment of a device according to the invention; the nozzle body shown in FIG. 2b can be referred to as a variant of the first embodiment, which differs from the first embodiment shown in FIG. 1 only in the number and arrangement of the outlet openings. It is clear from FIGS. 2a and 2b that the nozzle body 50 comprises precisely one interior space 120 that is fluidically connected to and/or can be brought into fluid connection with both the activation medium inlet duct 60 and the outlet openings 90. The nozzle body 50 comprises a guide member 52 for guiding the slider 110, which takes up about 10% of the length of the slider 110 relative to the first direction. In the present case, the guide member 52 is formed as a surface 52 that is recessed as compared to a separating surface 51 of the nozzle block such that an opening for the slider 110 to descend into the nozzle body 50 is simultaneously provided. Depending on how it is viewed, it may be stated that the perforated plate 50b in FIG. 2a comprises two groups 100a, 100b of outlet openings 90. Alternatively, it may also be stated that the perforated plate 50b comprises ten groups of outlet openings each lying one above other. The slider 110 of the first embodiment is configured to simultaneously close outlet openings 90 of different groups of outlet openings 90. The nozzle body 50 furthermore comprises precisely one interior space 120 that is or can be fluidically connected to both the activation medium inlet duct 60 and the outlet openings 90.

It is apparent from FIG. 2b that outlet openings 90 of a substantially uniform grid of outlet openings 90 may also be assigned to individual groups 100a, 100b of outlet openings 90. In the case shown in FIG. 2, for example, 13 groups of outlet openings each lying vertically one underneath the other are indicated. For the sake of clarity, only two groups 110a, 100b of these 13 groups have been provided with reference numbers.

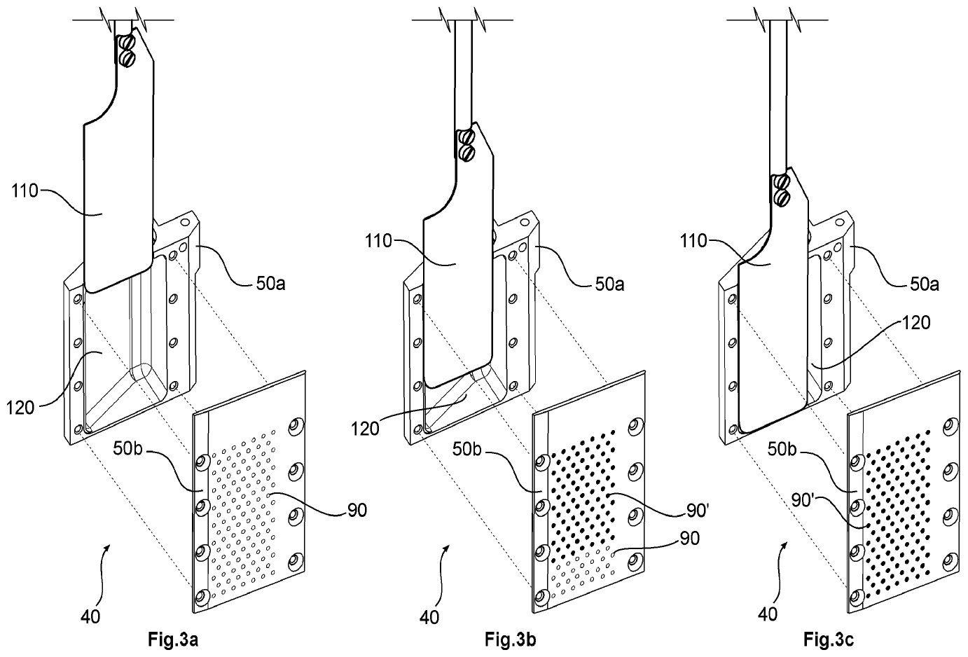

FIGS. 3a to 3c show exploded perspective views of the nozzle body 50 and the closure means 110 of the first embodiment of a device according to the invention in three different states. In the first state shown in FIG. 3a, the closure means 110 is arranged such that none of the outlet openings 90 is closed. In the second state shown in FIG. 3b, the closure means 110 is displaced downward in a vertical direction (more specifically in the direction of gravity) as compared to the first state. The nozzle body 50, more specifically the perforated plate 50b, therefore comprises closed outlet openings 90′ as well as not closed outlet openings 90. The closed outlet openings 90′ have a dark colour in FIGS. 3b and 3c for better visibility. In the third state shown in FIG. 3c, the closure means 110 is displaced further downward in the vertical direction (more specifically in the direction of gravity) as compared to the second state. In the state shown in FIG. 3c, the nozzle body 50, more specifically the perforated plate 50b, only comprises closed outlet openings 90′. The state shown in FIG. 3a can be assumed, for example, if a relatively wide workpiece is to be coated with a coating material. The state shown in FIG. 3b can be assumed, for example, if a narrower workpiece is to be coated with coating material. The state shown in FIG. 3c may, for example, be a stop, maintenance or safety state.

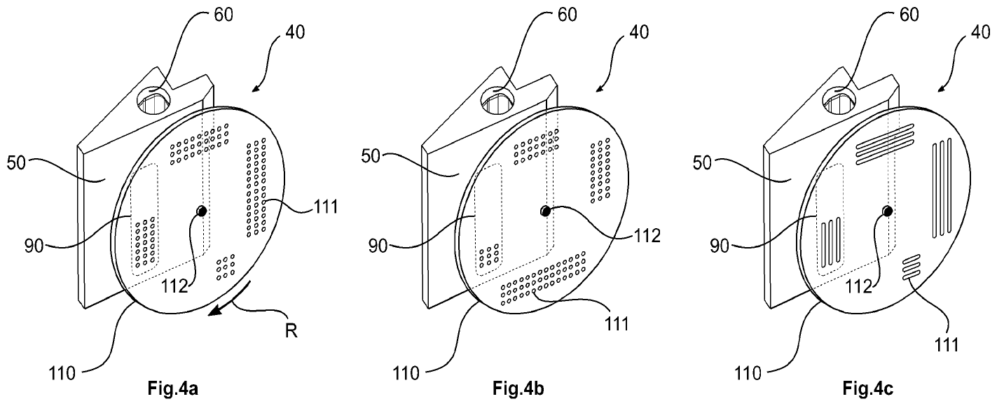

Shown in FIG. 4a is a perspective view of the nozzle body 50 and the closure means 110 of a second embodiment of a device according to the invention in a first state. In the shown second embodiment, the closure means 110 comprises four sectors, each of which has a different number of closure means openings 111 formed therein. The closure means 110 is substantially circular in shape. By rotating the closure means 110 about an axis 112, closure means openings 111 of a first sector, closure means openings 111 of a second sector, closure means openings 111 of a third sector, or closure means openings 111 of a fourth sector can, for example, be brought into fluidic connection with the outlet opening 90 of the nozzle body. The first sector comprises a first number of closure means openings 111, for example nine closure means openings 111. The second sector comprises a second number of closure means openings 111, for example 21 closure means openings 111. The third sector comprises a third number of closure means openings 111, for example 27 closure means openings 111. The fourth sector comprises a fourth number of closure means openings 111, for example 42 closure means openings 111. The closure means 110 may furthermore comprise at least one sector in which no closure means openings 111 are formed. The outlet opening 90 of the nozzle body 50 may, for example, be a substantially slit-shaped outlet opening 90.

FIG. 4b shows the nozzle body 50 and the closure means 110 of the second embodiment, which is also shown in FIG. 4a. However, FIG. 4b shows the second embodiment in a second state. Specifically, in the state shown in FIG. 4b, closure means openings 111 of a first sector of the closure means 110 are fluidically connected to the outlet opening 90 of the nozzle body 50, whereas in the state shown in FIG. 4a, closure means openings 111 of a second sector are connected to the outlet opening 90 of the nozzle body. The first sector and the second sector of the closure means 110 each comprise different numbers of closure means openings 111. The first state shown in FIG. 4a can, for example, be converted into the second state (cf. FIG. 4b) by rotating the closure means 110 about an axis 112. A possible direction of rotation is indicated by the reference sign R in FIG. 4a. By means of the device shown in FIGS. 4a and 4b, an activation medium can be allowed to flow out of different numbers of closure means openings 111 in each case. A coating method can therefore be performed with this device, in which the flow of an activation medium can be efficiently tailored to different workpiece and/or coating material geometries.

Shown in FIG. 4c is a perspective view of the nozzle body and the closure means of a variant of the second embodiment. The variant of the second embodiment shown in FIG. 4c substantially corresponds to the second embodiment shown in FIGS. 4a and 4b. However, the different sectors of the closure means 110 of the variant of the second embodiment do not have different numbers of closure means openings 111, but rather closure means openings 111 with different opening cross-sections. For example, the closure means openings 111 of a first sector may be elongated holes having a first length, the closure means openings 111 of a second sector may be elongated holes having a second length, the closure means openings 111 of a third sector may be elongated holes having a third length, and the closure means openings 111 of a fourth sector may be elongated holes having a fourth length.

By means of the variant of the second embodiment shown in FIG. 4c, an activation medium can be allowed to flow out of different opening cross-sections in each case. A coating method can therefore be performed with this device, in which the flow of an activation medium can be efficiently tailored to different workpiece and/or coating material geometries.

In a further variation of the second embodiment that is not shown, different sectors of a closure means 110 may have different numbers of closure means openings 111 with different opening cross-sections at least in parts.

1-23. (canceled)

24. A device for coating workpieces, said device comprising:
a feed device for feeding a coating material;
a pressing device for pressing the coating material onto a surface of a workpiece;
a conveying device for inducing a relative movement between the pressing device and the respective workpiece; and
an activation device for activating an adhesive on the coating material fed by the feed device and/or for activating an adhesive on the surface of the workpiece to be coated,
wherein the activation device comprises at least one supply line for supplying an activation medium as well as a nozzle body having an activation medium inlet duct and an activation medium outlet region, said activation medium outlet region comprising at least one outlet opening, and
wherein the activation device comprises precisely one closure means that is configured to close the outlet opening and/or individual outlet openings at least in parts.

25. The device according to claim 24, wherein the closure means is a slider that is substantially plate shaped and has a thickness of between 0.1 mm and 200 mm inclusive, and which is configured to assume different positions relative to the nozzle body by translational movement parallel to a first direction and/or by rotational movement about an axis of rotation, with different numbers of outlet openings being fluidically connected to the activation medium inlet duct in different positions of the slider.

26. The device according to claim 25, wherein the slider is configured to descend into a first end portion of the nozzle body, said nozzle body comprising, in the region of the first end portion, at least one guide member for guiding the slider which, with respect to the first direction, takes up at least 10% of the length of the slider relative to the first direction.

27. The device according to claim 24, wherein the closure means is arranged upstream of the outlet openings relative to the intended flow direction of the activation medium.

28. The device according to claim 27, wherein the nozzle body comprises an interior space, which is configured to be brought into fluidic connection with both the activation medium inlet duct and the outlet openings, with a guide member for guiding the closure means being formed in at least one section of the interior space.

29. The device according to claim 24, wherein the nozzle body is formed of a plurality of interconnected components, the closure means being slidably arranged between at least two of the plurality of interconnected components.

30. The device according to claim 24, wherein the closure means is arranged downstream of the outlet openings relative to the intended flow direction of the activation medium.

31. The device according to claim 30, wherein a guide member for guiding the closure means is formed on at least one side portion of the activation medium outlet region.

32. The device according to claim 26, wherein the activation medium inlet duct is formed in the first end portion.

33. The device according to claim 26, wherein the activation medium inlet duct is formed in a second end portion that is different from the first end portion, the second end portion being located opposite the first end portion or the activation medium outlet region.

34. The device according to claim 25, wherein the first direction and a main axis of the activation medium inlet duct form an angle of between 5° and 90° inclusive.

35. The device according to claim 24, wherein a first outlet opening has a larger cross-section than a second outlet opening, the first outlet opening being further away from the activation medium inlet duct than the second outlet opening.

36. The device according to claim 24, wherein the closure means comprises closure means openings which are arranged in such a manner that at least one of the closure means openings can be brought into fluidic connection, at least in part, with at least one outlet opening by shifting the closure means, said closure means comprising at least one closure means opening that has a larger opening cross-section than another closure means opening.

37. The device according to claim 36, wherein the closure means comprises a first portion in which a first number of closure means openings per area is provided, and at least one second portion in which a second number of closure means openings per area is provided, the first number per area and the second number per area being different.

38. The device according to claim 24, wherein the nozzle body comprises at least one first portion in which a first number of outlet openings per area is provided, and at least one second portion in which a second number of outlet openings per area is provided, the first number per area and the second number per area being different.

39. The device according to claim 24, further comprising at least one measuring means, said measuring means being a temperature, pressure, and/or flow rate sensor for measuring the temperature, pressure and/or flow rate of the activation medium.

40. The device according to claim 24, wherein the nozzle body comprises at least one interior space, said interior space comprising at least one flow directing member configured to mix and/or direct the activation medium.

41. The device according to claim 40, wherein the interior space comprises at least one flow directing member configured to influence the flow of the activation medium in such a manner that the average outflow velocities of individual outlet openings fluidically connected to the activation medium inlet duct do not deviate from one another by more than 50%.

42. The device according to claim 24, further comprising an adhesive application unit configured to apply the adhesive to the coating material fed by the feed device and/or to the surface of the workpiece to be coated.

43. The device according to claim 24, wherein the device is configured to rotate at least one of the activation device and the pressing device about at least one axis.

44. The device according to claim 24, wherein the closure means comprises a plurality of sectors that differ from one another, said closure means comprising, in a first sector of the plurality of sectors, a first number of closure means openings and/or closure means openings with a first opening cross-section, and said closure means comprising, in a second sector of the plurality of sectors, a second number of closure means openings and/or closure means openings with a second opening cross-section, said device being configured in such a manner that closure means openings of the first sector or closure means openings of the second sector can be brought into fluidic connection with the at least one outlet opening of the nozzle body by rotation and/or translation of the closure means, the first number and the second number being different numbers and the first opening cross-section and the second opening cross-section being different cross-sections.

45. The device according to claim 24, wherein the nozzle body is moved relative to the closure means, said closure means being substantially stationary, and the direction of movement of the nozzle body has a component that is parallel to the direction of gravity.

46. A method for coating and/or activating workpieces with the device according to claim 24, said method comprising:
actuating the precisely one closure means such that at least parts of the at least one outlet opening of the nozzle body which are not opposite the coating material and/or the surface of the workpiece to be coated are closed;
inducing a relative movement between the pressing device and the respective workpiece by the conveying device;
feeding the coating material by the feed device; and
applying and/or activating the adhesive on the coating material fed in the feed device and/or the surface of the workpiece to be coated by the device for coating workpieces.
